(19) United States
(12) Patent Application Publication
(10) Pub. No.: US 2019/0181708 A1
(43) Pub. Date: Jun. 13, 2019

(54) ROTARY ELECTRICAL MACHINE

(71) Applicant: DENSO CORPORATION, Kariya-city, Aichi-pref. (JP)

(72) Inventor: Takeo MAEKAWA, Kariya-city (JP)

(73) Assignee: DENSO CORPORATION, Kariya-city, Aichi-pref. (JP)

(21) Appl. No.: 16/093,505

(22) PCT Filed: Apr. 14, 2017
(86) PCT No.: PCT/JP2017/015328

§ 371 Date: Oct. 12, 2018

(30) Foreign Application Priority Data
Apr. 15, 2016 (JP) 2016-082310

(51) Int. Cl. H02K 1/32; H02K 1/27; H02K 1/30

(52) U.S. Cl. CPC H02K 1/32; H02K 1/30; H02K 1/276

(57) ABSTRACT

A rotor included in a rotary electrical machine has magnet, through holes, a rotor core, storage holes, introduction members, a side plate, etc. The introduction members communicate partly or entirely with openings of the one or more through holes and introduce a refrigerant. Each of the introduction members includes an intake portion, a protrusion portion, and a communication portion. The intake portion is provided at the one end of the protrusion portion and is opened toward the rotational direction of the rotor to take in the refrigerant. The protrusion portion protrudes axially from the end surface of the rotor. The communication portion is provided at the other end of the protrusion portion and communicates with the opening.

### TECHNICAL FIELD

The present disclosure relates to a rotary electrical machine including one or more magnets and one or more through holes.

### BACKGROUND ART

For example, PTL 1 discloses a technique relating to a rotor in a permanent magnet-type rotary machine intended to enhance the heat dissipation of spacers to improve the cooling efficiency of permanent magnets. This rotor includes a non-magnetic press plate on both end surfaces of a boss to suppress the axial displacement of the permanent magnets and the spacers. The rotor also has ventilation holes that penetrate through the press plates and the spacers in the axial direction.

### CITATION LIST

### Patent Literature

[PTL 1] JP 3480800 B

### SUMMARY OF THE INVENTION

### [Technical Problem]

However, when the technique described in PTL 1 is applied to a rotary electrical machine, the press plates disturb the outside air at the entrances to the ventilation holes during rotation. Accordingly, an air-curtain effect is produced at the entrances to the ventilation holes to block the flow of air into the ventilation holes. The air-curtain effect becomes more enhanced with increase in the rotation speed of the rotor.

The ventilation holes are provided in the spacers. Each of the spacers has a region with a small inter-electrode width to suppress leakage flux between magnets that are arranged circumferentially at the outer peripheral portion of the rotor. Each of the ventilation holes cannot have a large cross-sectional area. Accordingly, the flow rates of air into the ventilation holes for cooling are suppressed.

Due to the air-curtain effect and the cross-sectional areas of the ventilation holes described above, the air hardly passes through the ventilation holes even when the rotor rotates. As a result, the cooling effect cannot be obtained.

The present disclosure provides a rotary electrical machine implementing the following matters. A first object of the present disclosure is to introduce actively a refrigerant into a through hole without influence of the air-curtain effect. A second object of the present disclosure is to ensure the large cross-sectional area of the through hole to enhance the cooling effect.

### Solution to Problem

A first rotary electrical machine as an aspect of the technique of the present disclosure has: a rotor (13) that includes one or more magnet (13a) and one or more through holes (13b) penetrating in an axial direction; and a stator (11) that is opposed to the rotor. The first rotary electrical machine has an introduction member (16) that communicates partially or entirely with the one or more penetration holes and introduces a refrigerant (18a, 18b). The introduction member includes a protrusion portion (16b), an intake portion (16a), and a communication portion (16c). The protrusion portion protrudes axially from an end surface of the rotor. The intake portion is provided at one end of the protrusion portion and is opened toward the rotational direction of the rotor to take in the refrigerant. The communication portion is provided at the other end of the protrusion portion and communicates with the opening. As described above, in the first rotary electrical machine, the introduction member protrudes axially from the end surface of the rotor and is opened toward the rotational direction of the rotor. Accordingly, in the first rotary electrical machine, it is possible to introduce actively the refrigerant to cool the magnet without influence of the air-curtain effect.

In a second rotary electrical machine as an aspect of the technique of the present disclosure, the magnet is arranged closer to an outer radial side than to the through hole.

Accordingly, the refrigerant passing through the through hole is subjected to centrifugal action and moves in such a manner as to be attracted to the outer radial side on which the magnet is arranged. Accordingly, in the second rotary electrical machine, the magnet can be cooled efficiently.

In a third rotary electrical machine as an aspect of the technique of the present disclosure, the through hole communicates with a storage hole storing the magnet and has a barrier function to prevent magnetic leakage of the magnet. Accordingly, in the third rotary electrical machine, the refrigerant can cool not only the wall surface of the through hole but also the side surface of the magnet.

In a fourth rotary electrical machine as an aspect of the technique of the present disclosure, the introduction member is scoop-shaped. Accordingly, in the fourth rotary electrical machine, the refrigerant subjected to turning force can be passed into the through hole without waste. As a result, in the fourth rotary electrical machine, the magnet can be cooled effectively.

In a fifth rotary electrical machine as an aspect of the technique of the present disclosure, the intake portion is positioned closer to the outer radial side than to the communication portion. Accordingly, in the fifth rotary electrical machine, the amount of rotational movement becomes larger with increasing proximity to the outer radial side to take in a larger amount of refrigerant (increase the amount of refrigerant). As a result, in the fifth rotary electrical machine, the cooling efficiency is improved.

In a sixth rotary electrical machine as an aspect of the technique of the present disclosure, the intake portion includes an outer radial-side wall portion (16ae) and an inner radial-side wall portion (16ai) that extend axially from the end surface of the rotor. The outer radial-side wall portion has an inclination angle (first inclination angle) α relative to the radial direction and the inner radial-side wall portion has an inclination angle (second inclination angle) β relative to the radial direction. In this case, in the sixth rotary electrical machine, the inclination angles (the first and second inclination angles) α and β are in a relationship α>β. Accordingly, in the sixth rotary electrical machine, the inclination angle α of the outer radial-side wall portion is larger than the inclination angle β of the inner radial-side wall portion to take in a larger amount of refrigerant (increase the amount of refrigerant). As a result, in the sixth rotary electrical machine, the cooling efficiency is improved.

In a seventh rotary electrical machine as an aspect of the technique of the present disclosure, the introduction member has an internal height (16h) of the protrusion portion that is gradually smaller from the intake portion toward the communication portion. Accordingly, in the seventh rotary electrical machine, the refrigerant moving in the introduction member is increased in pressure. As a result, in the seventh rotary electrical machine, even when the axis of the rotor is long, the refrigerant is guided reliably to the opposite side surface of the through hole.

In an eighth rotary electrical machine as an aspect of the technique of the present disclosure, the introduction member has a surface-direction width (16w) of the protrusion portion that is gradually smaller from the intake portion toward the communication portion along the end surface of the rotor. Accordingly, in the eighth rotary electrical machine, the refrigerant moving in the introduction member is increased in pressure. As a result, in the eighth rotary electrical machine, even when the axis of the rotor is long, the refrigerant is guided reliably to the opposite side surface of the through hole.

In a ninth rotary electrical machine as an aspect of the technique of the present disclosure, the introduction members are provided on both end surfaces of the rotor. Further, in the ninth rotary electrical machine, the introduction members 16 are provided such that, on both end surfaces of the rotor, the through hole communicating with one end surface and the through hole communicating with the other end surface are different. Accordingly, in the ninth rotary electrical machine, the refrigerant is taken in from both end surfaces of the rotor and is discharged from the other end surface. As a result, in the ninth rotary electrical machine, cooling can be performed in a balanced manner.

In a tenth rotary electrical machine as an aspect of the technique of the present disclosure, the introduction member is provided such that the communication portion communicates with a plurality of openings. In addition, in the tenth rotary electrical machine, the refrigerant is branched so that an equal amount of refrigerant flows into the plurality of openings. Accordingly, in the tenth rotary electrical machine, an equal amount of refrigerant flows into the through holes. Therefore, in the tenth rotary electrical machine, the magnets corresponding to the through holes can be equally cooled.

In an eleventh rotary electrical machine as an aspect of the technique of the present disclosure, a plurality of openings is provided on a front side and a rear side with respect to the rotational direction of the rotor. A space from the opening on the front side to the inner wall surface of the protrusion portion (the volume of a first space) has a volume Vf, and a space from the opening on the rear side to the inner wall surface of the protrusion portion (the volume of a second space) has a volume Vr. In this case, in the eleventh rotary electrical machine, the volumes (the volumes of the first and second spaces) Vf and Vr are in a relationship Vf>Vr. Accordingly, in the eleventh rotary electrical machine, while the refrigerant taken in from the intake portion moves toward the through hole, the refrigerant becomes larger in pressure and flow rate with increasing proximity to the rear side in the rotational direction. As a result, in the eleventh rotary electrical machine, an equal amount of refrigerant flows into the through holes positioned on the front side and rear side with respect to the rotational direction of the rotor.

In a twelfth rotary electrical machine as an aspect of the technique of the present disclosure, the introduction member is molded integrally with a side plate (17) provided on the end surface of the rotor. Accordingly, in the twelfth rotary electrical machine, there is no need to prepare a separate introduction member. Therefore, in the twelfth rotary electrical machine, it is possible to suppress the manufacturing cost of the rotor. In addition, in the twelfth rotary electrical machine, the introduction member and the side plate are provided as one component. Accordingly, in the twelfth rotary electrical machine, there is no reduction in the work efficiency during manufacture of the rotor.

In a thirteenth rotary electrical machine as an aspect of the technique of the present disclosure, a material for the introduction member is a non-magnetic body or a material including a non-magnetic body. Accordingly, in the thirteenth rotary electrical machine, it is possible to suppress performance degradation due to flux leakage.

The “rotor” includes no field winding but has a magnet and a through hole. The “introduction member” has a protrusion portion, an intake portion, and a communication portion. Other components may be arbitrarily provided. The “communication” means that two elements are connected to each other to allow a refrigerant to flow therebetween. The “refrigerant” applies to air, oil, oil mist, or the like. The “side plate” is also called an end plate that is used for assembly of the rotor. The “outer radial side” means the outside with respect to the radial direction of the rotor, and the “inner radial side” means the inside with respect to the radial direction of the rotor. The “non-magnetic metal” refers to all metals unlikely to be attracted to a magnet, such as copper, aluminum, and stainless steel, for example. The “non-magnetic body” has no limitations on its material and composition, provided that magnetic flux is unlikely to flow therein. The non-magnetic body applies to non-metallic materials such as non-magnetic metals and resins. The “rotary electrical machine” may be any device with a shaft (rotation shaft). The rotary electrical machine applies to power generator, electric motor, motor generator, and others, for example. The power generator may be a motor generator acting as a power generator.

The electric motor may be a motor generator acting as an electric motor.

### BRIEF DESCRIPTION OF THE DRAWINGS

FIG. 1 is a schematic cross-sectional view of a first configuration example of a rotary electrical machine;

FIG. 2 a cross-sectional view of a first configuration example of a rotor illustrated in FIG. 1 taken along a line II-II of FIG. 1;

FIG. 3 is a side view of the first configuration example of the rotor illustrated in FIG. 1 as seen from a direction III of FIG. 1;

FIG. 4 a side view of the first configuration example of the rotor illustrated in FIG. 1 as seen from a direction IV of FIG. 1;

FIG. 5 is a schematic diagram illustrating a first configuration example of an introduction member;

FIG. 6 is a schematic diagram illustrating a second configuration example of the introduction member;

FIG. 7 is a schematic diagram illustrating a third configuration example of the introduction member;

FIG. 8 is a schematic diagram illustrating a fourth configuration example of the introduction member;

FIG. 9 is a schematic diagram illustrating a fifth configuration example of the introduction member;

FIG. 10 is a schematic diagram illustrating a sixth configuration example of the introduction member;

FIG. 11 is a schematic diagram illustrating a seventh configuration example of the introduction member;

FIG. 12 is a schematic diagram illustrating an eighth configuration example of the introduction member;

FIG. 13 is a schematic diagram illustrating a ninth configuration example of the introduction member;

FIG. 14 is a schematic diagram illustrating a tenth configuration example of the introduction member;

FIG. 15 is a schematic diagram illustrating an eleventh configuration example of the introduction member;

FIG. 16 is a schematic diagram illustrating a twelfth configuration example of the introduction member;

FIG. 17 is a schematic diagram illustrating a thirteenth configuration example of the introduction member;

FIG. 18 is a schematic cross-sectional view of a second configuration example of the rotary electrical machine;

FIG. 19 is a side view of a second configuration example of a rotor illustrated in FIG. 18 as seen from a direction XIX of FIG. 18;

FIG. 20 is a side view of the second configuration example of the rotor illustrated in FIG. 18 as seen from a direction XX of FIG. 18;

FIG. 21 is a schematic cross-sectional view of a third configuration example of the rotary electrical machine;

FIG. 22 is a schematic cross-sectional view of a fourth configuration example of the rotary electrical machine;

FIG. 23 is a cross-sectional view of a third configuration example of the rotor;

FIG. 24 is a side view of the third configuration example of the rotor;

FIG. 25 is a schematic view of a configuration example of an introduction member in which each pole is formed by one magnet; and

FIG. 26 is a side view of a fourth configuration example of the rotor.

### DESCRIPTION OF EMBODIMENTS

Embodiments for carrying out the technique of the present disclosure will be described below with reference to the drawings. Unless otherwise specified, the term “to connect” means electrical connection. Each of the drawings illustrates elements necessary for describing the technique of the present disclosure. Therefore, each of the drawings may not illustrate all the actual elements. The upward, downward, rightward, and leftward directions are expressed below based on the illustrations in the drawings. The magnets are hatched in the drawings for differentiation from other elements. Consecutive alphanumeric figures are abbreviated with the word “to”. The form for fixing two elements may be arbitrarily applied. Examples of the form for fixing include fastening with members such as bolts, screws, and pins, joining by welding a molten base material, adhesion with an adhesive, etc.

### First Embodiment

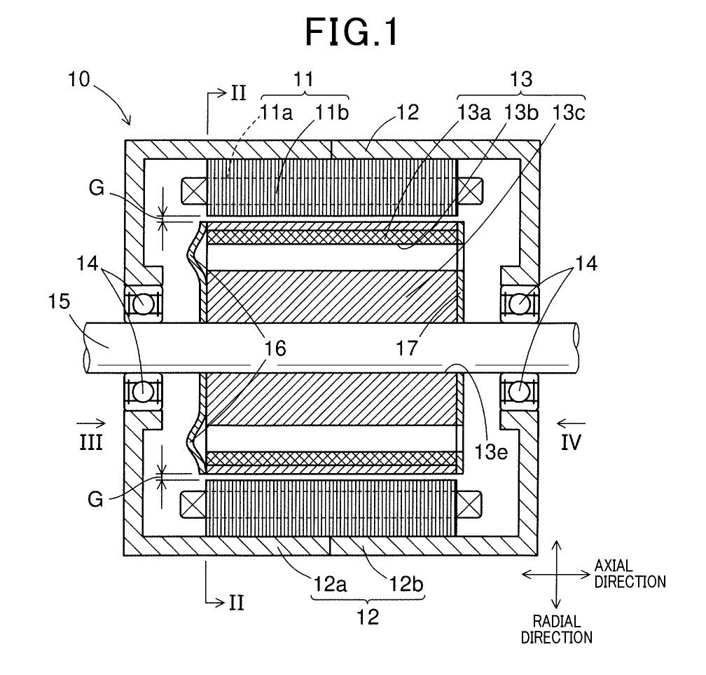

First embodiment will be described with reference to FIGS. 1 to 17. FIG. 1 illustrates an inner rotor-type rotary electrical machine 10. The rotary electrical machine 10 in the present embodiment has a stator 11, a rotor 13, bearings 14, a shaft 15, introduction members 16, a side plate 17, and the like in a frame 12.

The frame 12 corresponds to a “casing”, “housing”, and the like. The shape and material of the frame 12 can be arbitrarily decided as far as it can accommodate the stator 11, the rotor 13, the bearings 14, the shaft 15, the introduction members 16, the side plate 17, etc. The frame 12 supports and fixes at least the stator 11. The frame 12 further supports rotatably the shaft 15 via the bearings 14. The frame 12 in the present embodiment includes non-magnetic frame members 12a and 12b, etc. The frame members 12a and 12b may be integrally molded. Alternatively, the frame members 12a and 12b may be individually formed and then fixed to each other.

The stator 11 corresponds to an “armature”, and the like. The stator 11 includes a multi-phase winding 11a, a stator core 11b, etc. The stator core 11b can be arbitrarily configured as far as it is a solid soft magnetic body. The stator core 11b in the present embodiment is formed by laminating a large number of electromagnetic steel sheets, for example.

The multi-phase winding 11a is a winding of three or more phases stored and wound in a slot. The multi-phase winding 11a corresponds to an armature winding, a stator winding, a stator coil, and the like. The form of the multi-phase winding 11a can be arbitrarily decided. Therefore, the cross-sectional shape of the multi-phase winding 11a is not limited to a flat square but may be a circle or a triangle. The winding form of the multi-phase winding 11a can be arbitrarily decided. Examples of the winding form of the multi-phase winding 11a include full-pitch winding, distributed winding, concentrated winding, fractional pitch winding, and the like. The slot is a storage space in the stator core 11b.

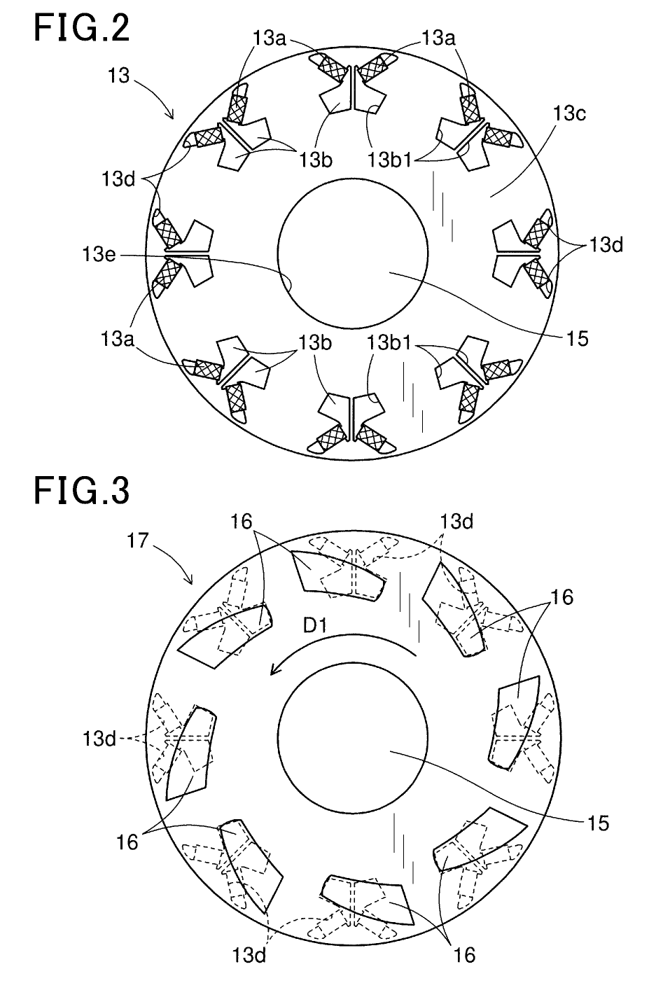

As illustrated in FIGS. 1 and 2, the rotor 13 in the present embodiment has magnets 13a, through holes 13b, a rotor core 13c, storage holes 13d, introduction members 16, a side plate 17, etc. The rotor 13 is opposed to the stator core 11b. The rotor 13 is fixed to the shaft 15. The rotor 13 and the shaft 15 rotate integrally. There is an air gap G between the rotor 13 and the stator 11. The width of the air gap G (the distance between the rotor 13 and the stator 11) can be arbitrarily decided in a range where magnetic flux flows between the rotor 13 and the stator 11 (an arbitrary value can be set within the range of numerical values of distance satisfying this condition).

The rotor core 13c can be arbitrarily configured as far as it is a solid soft magnetic body. The rotor core 13c in the present embodiment is formed by laminating a large number of electromagnetic steel sheets, for example. The through holes 13b and the storage holes 13d are aligned in the rotor core 13c in parallel with the axial direction. The through holes 13b and the storage holes 13d in the present embodiment communicate with each other.

The one or more magnets 13a are bar-like magnets that extend axially and are stored in the storage holes 13d. As illustrated in FIGS. 1 and 2, the magnets 13a in the present embodiment are arranged closer to the outer radial side than to the through holes 13b. An arbitrary number of magnets 13a can be provided according to the number of necessary poles. There are no limitations on the kind of the magnets 13a. As illustrated in FIG. 2, in the present embodiment, two each magnets 13a are provided for each pole. Examples of the kind of the magnets 13a include neodymium magnets and others.

The one or more through holes 13b are bar-like holes that extend axially to allow a refrigerant to flow and cool the magnets 13a. The through holes 13b in the present embodiment have a barrier function to prevent magnetic leakage of the magnets 13a. As illustrated in FIG. 2, the through holes 13b in the present embodiment are positioned closer to the inner radial side than to the storage holes 13d. Two each of the through holes 13b adjacent in the circumferential direction of the rotor 13 are deemed as one set, and eight sets are provided in the circumferential direction.

The introduction members 16 introduce a refrigerant to cool the magnets 13a. As illustrated in FIGS. 1 and 3, in the present embodiment, the introduction members 16 are provided on one end surface of the rotor 13 but are not provided on the other end surface of the rotor 13 as seen in the axial direction. An arbitrary number of the introduction members 16 may be provided according to the number of the magnets 13a, the number of the through holes 13b, etc. As illustrated in FIG. 3, in the present embodiment, eight introduction members 16 are provided according to the number of poles of the magnets 13a. A specific configuration example of the introduction members 16 will be described later.

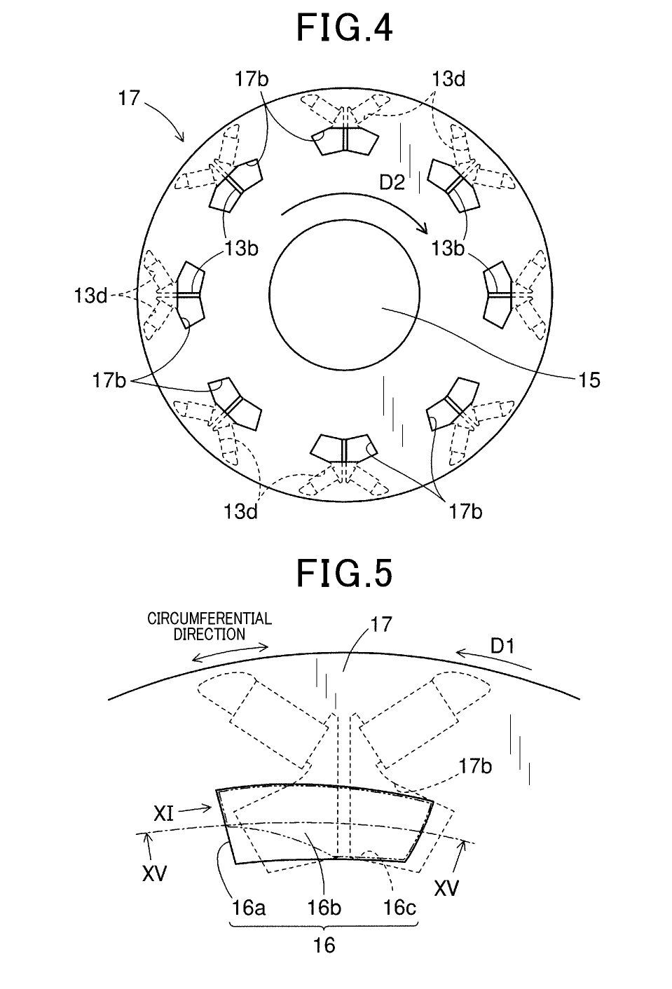

The side plate 17 is a member that is also called “end plate” and fixes the rotor core 13c with the magnets 13a stored in the storage holes 13d to the shaft 15. As illustrated in FIGS. 3 and 4, in the present embodiment, the side plate 17 has through holes 17b that communicate with the through holes 13b, and the like. The side plate 17 may include through holes (not illustrated) that communicate with the storage holes 13d. A rotational direction D1 of the rotor 13 illustrated in FIG. 3 and a rotational direction D2 of the rotor 13 illustrated in FIG. 4 are the same.

The introduction members 16 and the side plate 17 are formed from a non-magnetic body to suppress performance degradation due to flux leakage. There are no limitations on the substances and constitution of the non-magnetic body under the condition that magnetic flux is unlikely to flow in the non-magnetic body. Examples of the non-magnetic body include non-magnetic metals such as copper, aluminum, and stainless steel, and non-metallic materials such as resin. The introduction members 16 and the side plate 17 in the present embodiment are formed from a non-magnetic metal or a non-metallic material. The material for the introduction members 16 and the side plate 17 is desirably higher in thermal conductivity than the rotor core 13c to enhance heat dissipation. The introduction members 16 and the side plate 17 in the present embodiment are integrally molded.

A configuration example of the introduction members 16 will be described with reference to FIGS. 5 to 17. As illustrated in FIGS. 5 to 17, each of the introduction members 16 includes an intake portion 16a, a protrusion portion 16b, and a communication portion 16c. The shape of the introduction member 16 can be arbitrarily decided as far as it can guide a refrigerant 18a from the intake portion 16a through the protrusion portion 16b to the communication portion 16c. The introduction member 16 may have a shape with a continuous cross section such as scoop, pipe, tunnel, arcade, and arch, for example. The same elements illustrated in FIGS. 5 to 17 are given identical reference signs.

The intake portion 16a is provided at one end of the protrusion portion 16b and is opened toward the rotational direction D1 of the rotor 13 to take in a refrigerant. The refrigerant 18a is a fluid. The refrigerant may be air, oil, oil mist, or the like, for example. The intake portion 16a is provided along the radial direction of the rotor 13 unless otherwise specified. In the present embodiment, the air is used as the refrigerant 18a. The protrusion portion 16b protrudes axially from the end surface of the rotor 13. The communication portion 16c is provided at the other end of the protrusion portion 16b. The communication portion 16c communicates partly or entirely with an opening 13b1 of the through hole 13b illustrated in FIGS. 15 to 17. When the communication portion 16c and the opening 13b1 partly communicate with each other, the portion of the opening 13b1 not communicating with the communication portion 16c is blocked by the side plate 17.

First, a configuration example of the protrusion portion 16b of the introduction member 16, including its planar shape, arrangement, and number, will be described with reference to FIGS. 5 to 10.

As illustrated in FIG. 5, in the introduction member 16 of a first configuration example in the present embodiment, the intake portion 16a, the protrusion portion 16b, and the communication portion 16c are provided along the circumferential direction of the rotor 13. The refrigerant 18a taken in by the intake portion 16a is sent directly to both the through holes 13b adjacent to each other in the circumferential direction of the rotor 13 through the protrusion portion 16b and the communication portion 16c. The introduction member 16 may be configured as indicated with two-dot chain lines, including a ninth configuration example described later (see FIG. 13).

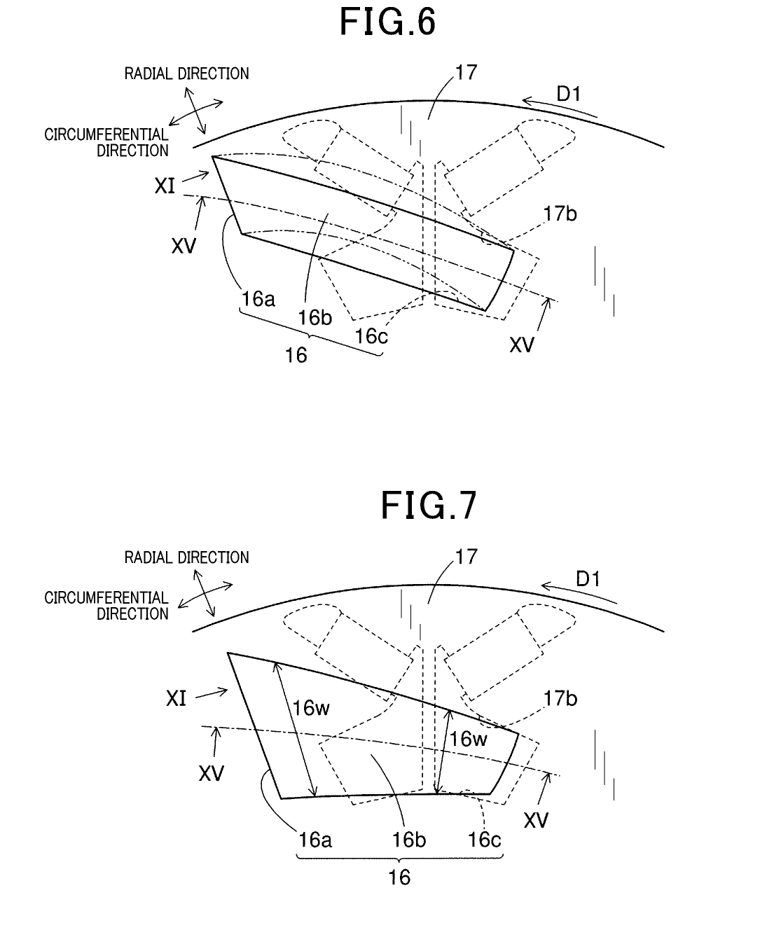

As illustrated in FIG. 6, the introduction member 16 of a second configuration example in the present embodiment has the intake portion 16a and the communication portion 16c shifted in the radial direction of the rotor 13. Specifically, the introduction member 16 has the intake portion 16a further radially outward than the communication portion 16c. The protrusion portion 16b connecting the intake portion 16a and the communication portion 16c may have a linear shape as indicated with solid lines. Alternatively, the protrusion portion 16b may have an arc shape or a curve shape as indicated with two-dot chain lines. As in the present configuration example, the intake portion 16a provided on the outer radial side has a larger amount of rotational movement than that of the introduction member 16 in the first configuration example. Accordingly, in the present configuration example, a larger amount of refrigerant is taken in.

As illustrated in FIG. 7, the introduction member 16 of a third configuration example in the present embodiment is shaped such that a surface-direction width 16w of the protrusion portion 16b along the end surface of the rotor 13 is gradually smaller from the intake portion 16a toward the communication portion 16c. That is, the introduction member 16 has the wide intake portion 16a to take in the refrigerant 18a. Accordingly, in the present configuration example, the refrigerant 18a is increased in pressure and is larger in flow rate while moving in the protrusion portion 16b.

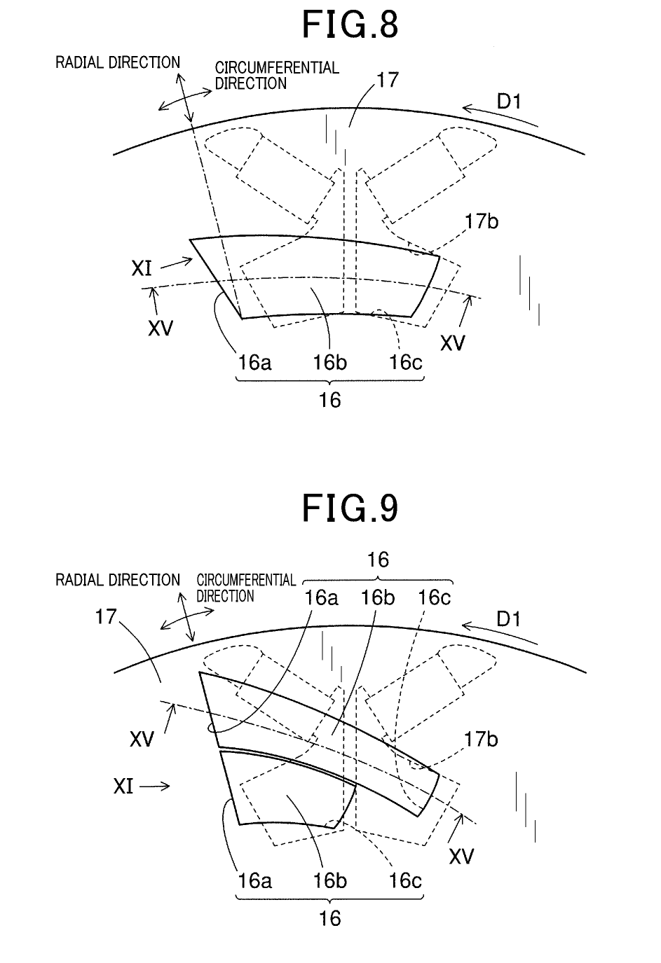

As illustrated in FIG. 8, in the introduction member 16 of a fourth configuration example in the present embodiment, an outer radial-side portion of the intake portion 16a protrudes toward the rotational direction D1 of the rotor 13 more than an inner radial-side portion of the intake portion 16a. That is, the introduction member 16 is larger in circumference and increased in the amount of rotational movement with increasing proximity to the outer radial side. Accordingly, in the present configuration example, the intake amount of the refrigerant 18a can be increased.

As illustrated in FIG. 9, the number of the introduction members 16 of a fifth configuration example in the present embodiment corresponds to the number of the through holes 13b. As illustrated in FIG. 2, in the present embodiment, two each through holes 13b are provided for each pole of the magnet 13a. Accordingly, as illustrated in FIG. 9, two each introduction members 16 in the present configuration example are provided in the same manner. The two introduction members 16 are arranged on the outer radial side and the inner radial side such that they communicate with the corresponding through holes 13b. Referring to FIG. 9, the introduction member 16 illustrated on the upper side corresponds to the introduction member 16 on the outer radial side and the introduction member 16 illustrated on the lower side corresponds to the introduction member 16 on the inner radial side. To cool equally the two magnets 13a by equalizing the flow rates of the refrigerant 18a into the two through holes 13b, the two introduction members 16 desirably have the intake portions 16a equal in opening areas.

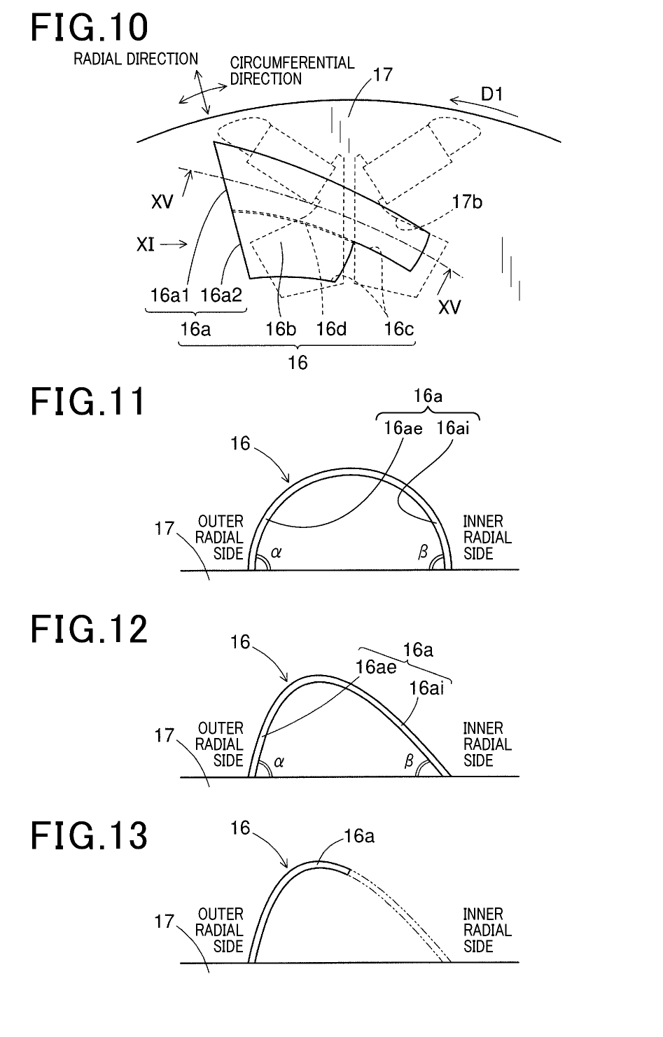

As illustrated in FIG. 10, the introduction member 16 of a sixth configuration example in the present embodiment is a modification of the fifth configuration example. The fifth configuration example has the two introduction members 16. In contrast to this, the present configuration example has one introduction member 16 with a division wall 16d. The division wall 16d is provided from the intake portion 16a to the communication portion 16c. An outer radial-side first intake portion 16a1 divided by the division wall 16d corresponds to the outer radial-side intake portion 16a illustrated in FIG. 9. An inner radial-side second intake portion 16a2 corresponds to the inner radial-side intake portion 16a illustrated in FIG. 9. As in the case with the fifth configuration example, to cool equally the two magnets 13a, the first intake portion 16a1 and the second intake portion 16a2 are desirably equal in opening area.

Next, a configuration example of the front shape of the intake portion 16a of the introduction member 16 will be described with reference to FIGS. 11 to 14.

As illustrated in FIG. 11, the introduction member 16 of a seventh configuration example in the present embodiment has an intake portion 16a with a semi-circular front surface. Specifically, the introduction member 16 has the semi-circular intake portion 16a including an outer radial-side wall portion 16ae and an inner radial-side wall portion 16ai. The outer radial-side wall portion 16ae has an inclination angle (first inclination angle) α relative to the radial direction, and the inner radial-side wall portion 16ai has an inclination angle (second inclination angle) β relative to the radial direction. In this case, the first and second inclination angles α and β are in a relationship α=β. That is, the introduction member 16 has the equal inclination angles α and β with respect to the outer radial-side wall and the inner radial-side wall. Accordingly, in the present configuration example, the refrigerant 18a is equally taken in on the outer radial side and the inner radial side of the introduction member 16.

As illustrated in FIG. 12, the introduction member 16 of an eighth configuration example in the present embodiment has the intake portion 16a including an outer radial-side wall portion 16ae and an inner radial-side wall portion 16ai. The outer radial-side wall portion 16ae has an inclination angle (first inclination angle) α relative to the radial direction, and the inner radial-side wall portion 16ai has an inclination angle (second inclination angle) β relative to the radial direction. In this case, the first and second inclination angles α and β are in a relationship α>β. That is, in the introduction member 16, the inclination angle α of the outer radial-side wall portion 16ae is larger than the inclination angle β of the inner radial-side wall portion 16ai. Accordingly, the introduction member 16 becomes larger in circumference and increases in the amount of rotational movement with increasing proximity to the outer radial side. Therefore, in the present configuration example, the intake amount of the refrigerant 18a can be increased.

As illustrated in FIG. 13, the introduction member 16 of a ninth configuration example in the present embodiment has the intake portion 16a of an inverse J shape from the outer radial-side end to the peak portion. As illustrated with the two-dot chain lines in FIGS. 13 and 5, the introduction member 16 is configured such that the axial protrusion is gradually closed from the intake portion 16a to the middle of the protrusion portion 16b. Accordingly, in the present configuration example, the refrigerant 18a is guided toward the communication portion 16c.

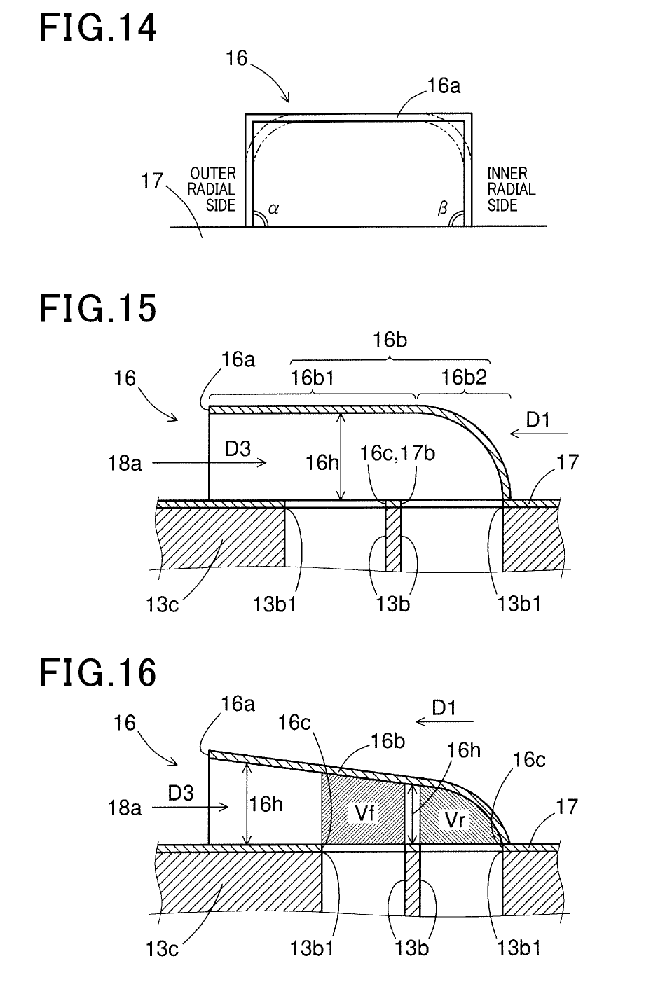

As illustrated in FIG. 14, the introduction member 16 of a tenth configuration example in the present embodiment has the intake portion 16a with a square front surface together with the side plate 17. In the present configuration example, as in the case with the seventh configuration example illustrated in FIG. 11, the inclination angles α and β of the outer radial-side and inner radial-side walls are equal. Accordingly, in the present configuration example, the refrigerant 18a is equally taken in on the outer radial side and inner radial side of the introduction member 16. The introduction member 16 of the present configuration example may be configured such that the inclination angle α of the outer radial-side wall portion 16ae and the inclination angle β of the inner radial-side wall portion 16ai are in the relationship of α>β (not illustrated) as in the eighth configuration example illustrated in FIG. 12. In addition, the introduction member 16 of the present configuration example may be configured to have an inverse L shape from the outer radial-side end to the peak portion as in the ninth configuration example illustrated in FIG. 13. Further, as illustrated with two-dot chain lines in FIG. 14, the introduction member 16 in the present configuration example may be configured such that the intake portion 16a is partly curved (at the corners of the square shape).

Further, a configuration example of a cross-sectional shape of the protrusion portion 16b of the introduction member 16 will be described with reference to FIGS. 15 to 17. Each of FIGS. 15 to 17 illustrates the flow of the refrigerant 18a with arrow D3 (hereinafter, called “introduction direction D3”). As indicated by the introduction direction D3 in each of the drawings, the refrigerant 18a is taken into the introduction member 16 via the intake portion 16a. After that, the refrigerant 18a flows along the protrusion portion 16b of the introduction member 16, and then flows into the through hole 13b of the rotor 13 through the communication portion 16c and the through hole 17b. An internal height 16h illustrated in FIGS. 15 to 17 refers to the height of the space in which the refrigerant 18a flows in the introduction member 16.

As illustrated in FIG. 15, the introduction member 16 of an eleventh configuration example in the present embodiment includes the protrusion portion 16b having a first protrusion portion 16b1 and a second protrusion portion 16b2. The first protrusion portion 16b1 is a portion in which the internal height 16h from the intake portion 16a to the side plate 17 does not change. The second protrusion portion 16b2 is a region that is arc-shaped in cross section and includes the communication portion 16c on the rear side (the right side of FIG. 15) with respect to the rotational direction D1 of the rotor 13. Accordingly, the internal height 16h is low in the second protrusion portion 16b2.

As illustrated in FIG. 16, the introduction member 16 of a twelfth configuration example in the present embodiment has the protrusion portion 16b in which the internal height 16h becomes gradually lower from the intake portion 16a to the communication portion 16c. Accordingly, in the present configuration example, the refrigerant 18a is enhanced in pressure and is increased in flow rate while moving in the introduction member 16.

The magnet 13a is equally cooled in the two through holes 13b. Accordingly, the refrigerant 18a is desirably branched such that the flow rates into the openings 13b1 become equal. The present configuration example is configured such that a volume Vf of a first space hatched in FIG. 16 and a volume Vr of a second space hatched in FIG. 6 are in a relationship Vf>Vr. The volume Vf of the first space is the volume of a space from the front-side opening 13b1 with respect to the rotational direction D1 of the rotor 13 to the inner wall surface of the protrusion portion 16b (the left part hatched in FIG. 16). The volume Vr of the second space is the volume of a space from the rear-side opening 13b1 with respect to the rotational direction D1 of the rotor 13 to the inner wall surface of the protrusion portion 16b (the right part hatched in FIG. 16).

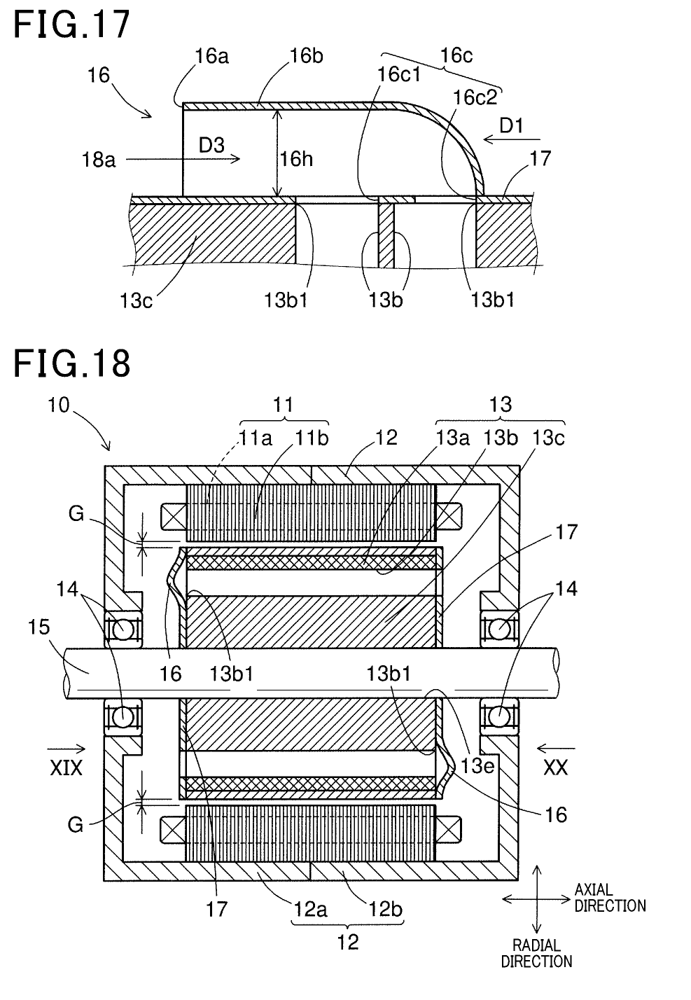

As illustrated in FIG. 17, the introduction member 16 of a thirteenth configuration example in the present embodiment is a modification of the eleventh configuration example. The present configuration example is different from the eleventh configuration example in including the communication portion 16c that equalizes the flow rates of the refrigerant 18a into the two through holes 13b. In the twelfth configuration example, the volume Vf of the first space and the volume Vr of the second space are in the relationship Vf>Vr. In contrast to this, the communication portion 16c of the present configuration example has a first communication portion 16c1 and a second communication portion 16c2 different in opening area. The first communication portion 16c1 has an opening area (first area) Sf, and the second communication portion 16c2 has an opening area (second area) Sr. In this case, the opening areas of the communication portions are preferably configured such that the first area Sf and the second area Sr are in the relationship Sf>Sr.

The introduction member 16 in the present embodiment can be formed by combining the configurations of the examples described above. Specifically, the first to sixth configuration examples relating to the planar shape of the protrusion portion 16b, the seventh to tenth configuration examples relating to the planar shape of the intake portion 16a, and the eleventh to thirteenth configuration examples relating to the cross-sectional shape of the protrusion portion 16b can be combined in any way. Accordingly, there are a total of 72 (=6×4×3) combinations of the introduction member 16 in the present embodiment. For example, for the introduction member 16, there are combinations of {the first configuration example, the seventh configuration example, and the eleventh configuration example}, combinations of {the second configuration example, the eighth configuration example, and the twelfth configuration example}, combinations of {the third configuration example, the ninth configuration example, and the thirteenth configuration example}, combinations of {the sixth configuration example, the tenth configuration example, and the thirteenth configuration example}, etc. For the introduction member 16 in the present embodiment, the configurations of the examples can be combined depending on the specifications and rating of the rotary electrical machine 10, the forms of the magnets 13a and the through holes 13b (for example, shape, size, and number), and others, for example.

The foregoing rotary electrical machine 10 in the present embodiment produces the advantageous effects described below.

(1) The rotary electrical machine 10 illustrated in FIG. 1 has the rotor 13, the stator 11, etc. The rotor 13 has the magnets 13a, the through holes 13b, the rotor core 13c, the storage holes 13d, the introduction members 16, the side plate 17, etc. The introduction members 16 communicate partly or entirely with the openings 13b1 of the one or more through holes 13b and introduce the refrigerant 18a. Each of the introduction members 16 includes the intake portion 16a, the protrusion portion 16b, and the communication portion 16c. As illustrated in FIGS. 5 to 10, the intake portion 16a is provided at the one end of the protrusion portion 16b and is opened toward the rotational direction D1 of the rotor 13 to take in the refrigerant 18a. The protrusion portion 16b protrudes axially from the end surface of the rotor 13. As illustrated in FIGS. 15 to 17, the communication portion 16c is provided at the other end of the protrusion portion 16b. The communication portion 16c communicates with the two openings 13b1 adjacent to each other in the circumferential direction. In this way, in the rotary electrical machine 10, the introduction members 16 protrude axially from the end surface of the rotor 13 and are opened toward the rotational direction D1 of the rotor 13. Accordingly, in the rotary electrical machine 10, the refrigerant 18a can be actively introduced without influence of the air-curtain effect. As a result, in the rotary electrical machine 10, it is possible to cool efficiently the magnets 13a that might suffer performance degradation due to temperature rise. Accordingly, in the rotary electrical machine 10, it is possible to suppress decrease in the characteristics and performance of the magnets 13a. In addition, in the rotary electrical machine 10, it is possible to reduce the amount of dysprosium used to avoid thermal demagnetization of the magnets 13a (the usage of rare earth element). Accordingly, in the rotary electrical machine 10, it is possible to suppress the manufacturing cost of the rotor 13. In the rotary electrical machine 10, each of the two openings 13b1 communicates with the corresponding storage hole 13d in which the magnet 13a is stored. Accordingly, in the rotary electrical machine 10, both magnets 13a can be efficiently cooled.

(2) As illustrated in FIGS. 1 and 2, in the rotary electrical machine 10, the magnets 13a are arranged closer to the outer radial side than to the through holes 13b. Accordingly, the refrigerant 18a passing through the through holes 13b moves in such a manner as to be attracted to the outer radial side on which the magnets 13a are arranged under centrifugal action. Accordingly, in the rotary electrical machine 10, the magnets 13a can be efficiently cooled.

(3) As illustrated in FIGS. 2 to 10, in the rotary electrical machine 10, the through holes 13b communicate with the storage holes 13d storing the magnets 13a and have the barrier function to prevent magnetic leakage of the magnets 13a. Accordingly, the through holes 13b act as magnetic leakage preventive barriers to prevent magnetic leakage of the magnets 13a. Accordingly, in the rotary electrical machine 10, the refrigerant 18a can cool not only the wall surfaces of the through holes 13b but also the side surfaces of the magnets 13a.

(4) As illustrated in FIGS. 5 to 17, in the rotary electrical machine 10, the introduction members 16 are scoop-shaped. Accordingly, in the rotary electrical machine 10, the refrigerant 18a subjected to rotational force can be passed into the through holes 13b without waste. As a result, in the rotary electrical machine 10, the magnets 13a can be efficiently cooled.

(5) As illustrated in FIG. 6, in the rotary electrical machine 10, the intake portion 16a is positioned closer to the outer radial side than to the communication portion 16c. Accordingly, in the rotary electrical machine 10, the amount of rotational movement becomes larger with increasing proximity to the outer radial side to take in a larger amount of refrigerant 18a (increase the amount of refrigerant). As a result, in the rotary electrical machine 10, the cooling efficiency is improved.

(6) As illustrated in FIG. 12, in the rotary electrical machine 10, the intake portion 16a includes the outer radial-side wall portion 16ae and the inner radial-side wall portion 16ai that extend axially from the end surface of the rotor 13. The outer radial-side wall portion 16ae has the inclination angle (first inclination angle) α relative to the radial direction and the inner radial-side wall portion 16ai has the inclination angle (second inclination angle) β relative to the radial direction. In this case, in the rotary electrical machine 10, the first and second inclination angles α and β are in the relationship α>β. Accordingly, in the rotary electrical machine 10, the inclination angle α of the outer radial-side wall portion 16ae is larger than the inclination angle β of the inner radial-side wall portion 16ai to take in a larger amount of the refrigerant 18a (increase the amount of the refrigerant). As a result, in the rotary electrical machine 10, the cooling efficiency is improved.

(7) As illustrated in FIG. 16, in the rotary electrical machine 10, the introduction member 16 has the internal height (16h) of the protrusion portion 16b that is gradually smaller from the intake portion 16a toward the communication portion 16c. Accordingly, in the rotary electrical machine 10, the refrigerant 18a is gradually increased in pressure while moving in the introduction member 16. As a result, in the rotary electrical machine 10, even when the axis of the rotor 13 illustrated in FIG. 1 is long, the refrigerant 18a is guided reliably to the opposite side surface (the right side surface in FIG. 1) of the through hole 13b.

(8) As illustrated in FIG. 7, in the rotary electrical machine 10, the surface-direction width (16w) of the protrusion portion 16b is gradually smaller from the intake portion 16a toward the communication portion 16c along the end surface of the rotor 13. Accordingly, in the rotary electrical machine 10, the refrigerant 18a is gradually increased in pressure while moving in the introduction member 16. As a result, in the rotary electrical machine 10, even when the axis of the rotor 13 illustrated in FIG. 1 is long, the refrigerant 18a is guided reliably to the opposite side surface (the right side surface in FIG. 1) of the through hole 13b.

(10) As illustrated in FIGS. 15 to 17, in the introduction member 16 of the rotary electrical machine 10, the introduction member 16 is provided such that the communication portion 16c communicates with the plurality of openings 13b1. The refrigerant 18a is branched such that an equal amount of refrigerant 18a flows into the plurality of openings 13b1. Accordingly, in the rotary electrical machine 10, an equal amount of refrigerant 18a flows into the through holes 13b. Accordingly, in the rotary electrical machine 10, the magnets 13a corresponding to the through holes 13b can be equally cooled.

(11) As illustrated in FIGS. 15 to 17, in the rotary electrical machine 10, the plurality of openings 13b1 is provided on the front side and the rear side with respect to the rotational direction D1 of the rotor 13. As illustrated in FIG. 16, the first space from the front-side opening 13b1 to the inner wall surface of the protrusion portion 16b has the volume Vf, and the second space from the rear-side opening 13b1 to the inner wall surface of the protrusion portion 16b has the volume Vr. In this case, in the rotary electrical machine 10, the first and second spaces Vf and Vr are in the relationship Vf>Vr. Accordingly, in the rotary electrical machine 10, while the refrigerant 18a taken in from the intake portion 16a moves toward the through hole 13b, the refrigerant 18a is increased in pressure and flow rate with increasing proximity to the rear side in the rotational direction D1. As a result, in the rotary electrical machine 10, an equal amount of refrigerant 18a flows into the through holes 13b positioned on the front side and rear side with respect to the rotational direction D1 of the rotor 13.

(12) As illustrated in FIGS. 1 and 15 to 17, in the rotary electrical machine 10, the introduction member 16 is molded integrally with the side plate 17 provided on the end surface of the rotor 13. Accordingly, in the rotary electrical machine 10, there is no need to prepare a separate introduction member 16. Accordingly, in the rotary electrical machine 10, it is possible to suppress the manufacturing cost of the rotor 13. In addition, in the rotary electrical machine 10, the introduction member 16 and the side plate 17 are provided as one component. Accordingly, in the rotary electrical machine 10, there is no reduction in the work efficiency during manufacture of the rotor 13.

(13) As illustrated in FIG. 1, in the rotary electrical machine 10, the material for the introduction member 16 is a non-magnetic body or a material including a non-magnetic body. Accordingly, in the rotary electrical machine 10, it is possible to suppress performance degradation due to flux leakage.

### Second Embodiment

A second embodiment will be described with reference to FIGS. 18 to 20. For simplicity of illustration and description, unless otherwise specified, the same components as those of the first embodiment will be given the same reference signs and description thereof will be omitted. Accordingly, differences from the first embodiment will be mainly described.

FIG. 18 illustrates an inner rotor-type rotary electrical machine 10. The rotary electrical machine 10 in the present embodiment has a stator 11, a rotor 13, a bearing 14, a shaft 15, introduction members 16, a side plate 17, and others in a frame 12, as in the first embodiment. In the first embodiment, all the introduction members 16 are provided at one end surface of the rotor 13 as seen from the axial direction as illustrated in FIG. 1. The rotary electrical machine 10 in the present embodiment is different from the rotary electrical machine 10 in the first embodiment in the position of the introduction members 16.

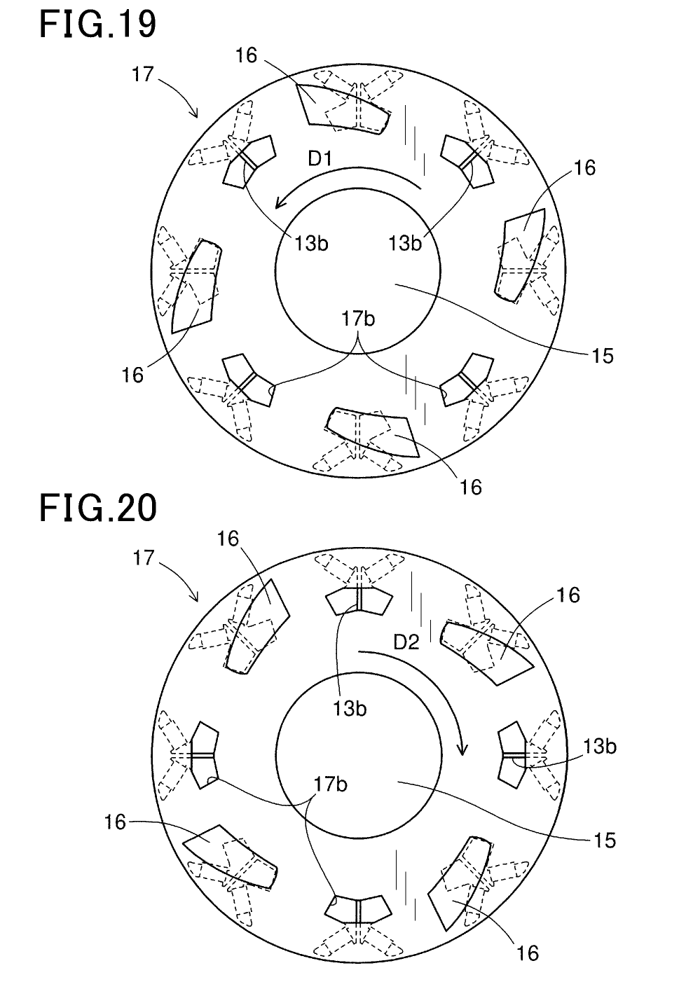

In the rotary electrical machine 10 in the present embodiment, as illustrated in FIG. 18, the introduction members 16 are provided on both end surfaces of the rotor 13. Further, in the rotary electrical machine 10, as illustrated in FIGS. 19 and 20, the introduction members 16 are provided such that, on both end surfaces of the rotor 13, the through hole 13b communicating on one end surface and the through hole 13b communicating on the other end surface are different. The introduction members 16 in the present embodiment are configured in the same manner as those in the first embodiment.

In the rotary electrical machine 10 in the present embodiment, the same advantageous effects as those in the first embodiment can be obtained and the following advantageous effects can also be obtained.

(9) As illustrated in FIGS. 18 to 20, in the rotary electrical machine 10, the introduction members 16 are provided on both end surfaces of the rotor 13. Further, in the rotary electrical machine 10, the introduction members 16 are provided such that, on both end surfaces of the rotor 13, the through hole 13b communicating with one end surface and the through hole 13b communicating with the other end surface are different. Accordingly, in the rotary electrical machine 10, the refrigerant 18a is taken in from both end surfaces of the rotor 13 and is discharged from the other end surface. As a result, in the rotary electrical machine 10, cooling can be performed in a balanced manner.

### Third Embodiment

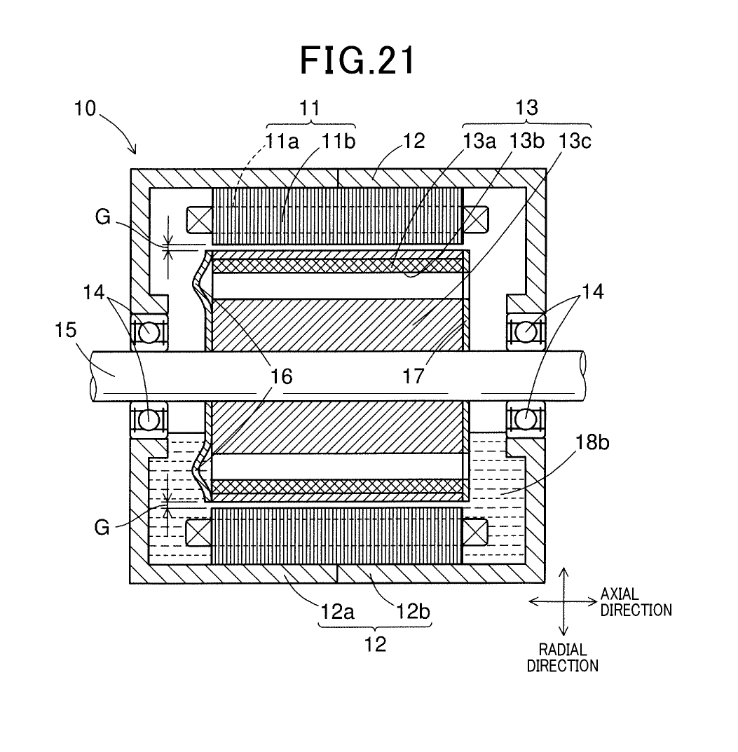

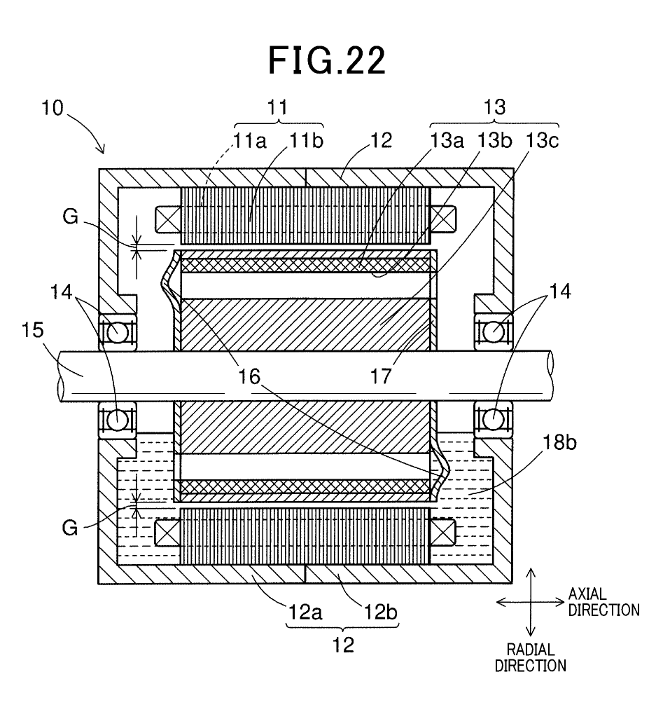

A third embodiment will be described with reference to FIGS. 21 and 22. For simplicity of illustration and description, unless otherwise specified, the same components as those of the first to second embodiments will be given the same reference signs and description thereof will be omitted. Accordingly, differences from the first and second embodiments will be mainly described.

FIGS. 21 and 22 illustrate an inner rotor-type rotary electrical machine 10. The rotary electrical machine 10 in the present embodiment has a stator 11, a rotor 13, a bearing 14, a shaft 15, introduction members 16, a side plate 17, and others in a frame 12, as in the first embodiment. In the first and second embodiments, the air is used as the refrigerant 18a. The rotary electrical machine 10 in the present embodiment is different from the rotary electrical machines 10 in the first and second embodiments in that oil is used as the refrigerant 18b. In the present embodiment, the capacity for the refrigerant 18b is desirably set such that the introduction members 16 on the lower sides of FIGS. 21 and 22 are under the liquid level.

The rotary electrical machine 10 illustrated in FIG. 21 is similar to the rotary electrical machine 10 illustrated in FIG. 1 (the rotary electrical machine 10 in the first embodiment) except for the refrigerant 18b. Accordingly, in the rotary electrical machine 10 in the present embodiment, the same advantageous effects as those of the first embodiment can be obtained. In addition, the rotary electrical machine 10 illustrated in FIG. 22 is similar to the rotary electrical machine 10 illustrated in FIG. 18 (the rotary electrical machine 10 in the second embodiment) except for the refrigerant 18b. Accordingly, in the rotary electrical machine 10 in the present embodiment, the same advantageous effects as those of the second embodiment can be obtained.

### Fourth Embodiment

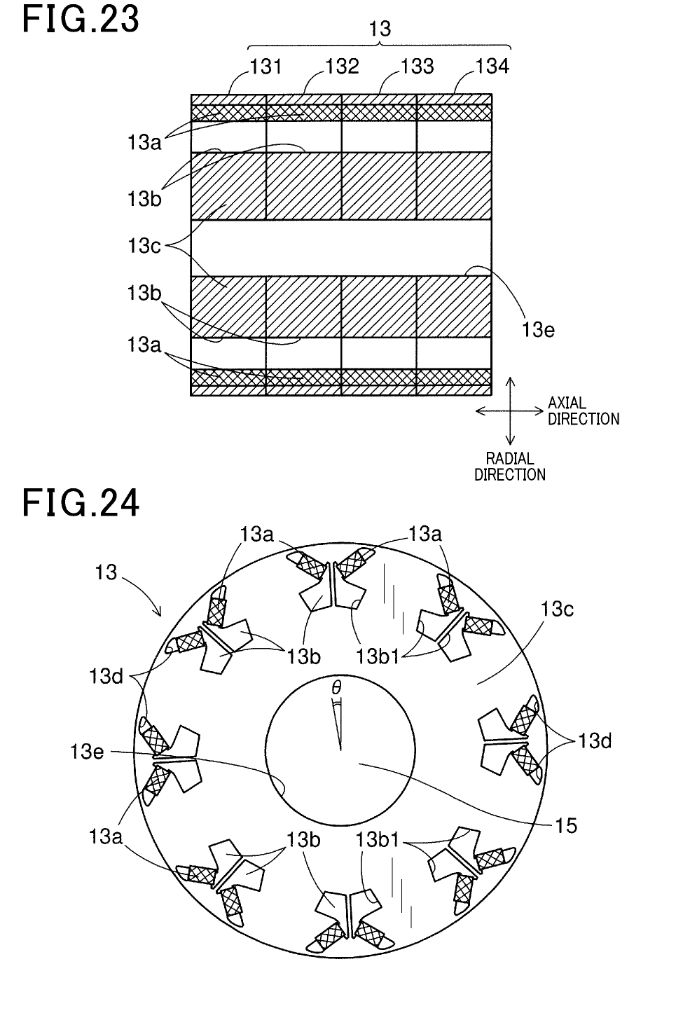

A fourth embodiment will be described with reference to FIGS. 23 and 24. For simplicity of illustration and description, unless otherwise specified, the same components as those of the first to third embodiments will be given the same reference signs and description thereof will be omitted. Accordingly, differences from the first to third embodiments will be mainly described.

The rotor 13 illustrated in FIG. 23 is a substitute for the rotors 13 illustrated in FIGS. 1, 18, 21, and 22. The rotor 13 in the present embodiment has a plurality of partial rotors 131 to 134. The partial rotors 131 to 134 are configured in the same manner as the rotors 13 illustrated in FIGS. 1, 18, 21, and 22. The partial rotors 131 to 134 are different from those in the first to third embodiments in that the axial length is shorter. In the present embodiment, the rotor 13 has the four partial rotors 131 to 134, but the technique of the present disclosure is not limited to this. The number of the partial rotors included in the rotor 13 can be arbitrarily set to two or more.

The partial rotors 131 and 133 are configured as illustrated in FIG. 2, for example. The partial rotors 132 and 134 are configured as illustrated in FIG. 24, for example. With the partial rotors 131 and 133 configured as illustrated in FIG. 2 at reference positions, the partial rotors 132 and 134 are positioned with a turn of an angle θ. In the present embodiment, the partial rotors 132 and 134 are shifted at the angle θ circumferentially. Accordingly, as illustrated in FIG. 23, the positions of the magnets 13a and the through holes 13b are shifted circumferentially. In this manner, in the present embodiment, even when the through holes 13b are shifted circumferentially, the refrigerant 18a or 18b passes through the introduction members 16 and flow from one axial end surface to the other axial surface illustrated in FIG. 23. Accordingly, in the present embodiment, the same advantageous effects as those of the first to third embodiment can be obtained.

In the rotor 13 in the present embodiment, the plurality of partial rotors 131 to 134 can be shifted in any way as far as the refrigerant 18a or 18b can flow from the one axial end surface to the other axial end surface. For example, in the rotor 13, the partial rotors 131 and 134 may be arranged at reference positions and the partial rotors 132 and 133 may be arranged at positions with a turn of the angle θ. Alternatively, in the rotor 13, the partial rotor 131 may be arranged at a reference position, the partial rotor 132 may be arranged at a position with a turn of an angle 2θ, the partial rotor 133 may be arranged at a position turned with a turn of an angle 3θ, and the partial rotor 134 may be arranged at a position with a turn of an angle 4θ. Still alternatively, in the rotor 13, the angle θ at which the partial rotors 131 to 134 are shifted may not be constant but may be changed. In the rotary electrical machine 10 in the present embodiment, even when each of the partial rotors 131 to 134 is arranged in any way, the same advantageous effects as those of the first to third embodiments can be obtained as far as the foregoing condition (that the refrigerant 18a or 18b can flow) is satisfied.

### Other Embodiments

The first to fourth embodiments as modes for carrying out the technique of the present disclosure have been described so far, but the technique of the present disclosure is not limited to them. The technique of the present disclosure can be carried out in various manners. For example, the following modes may be implemented.

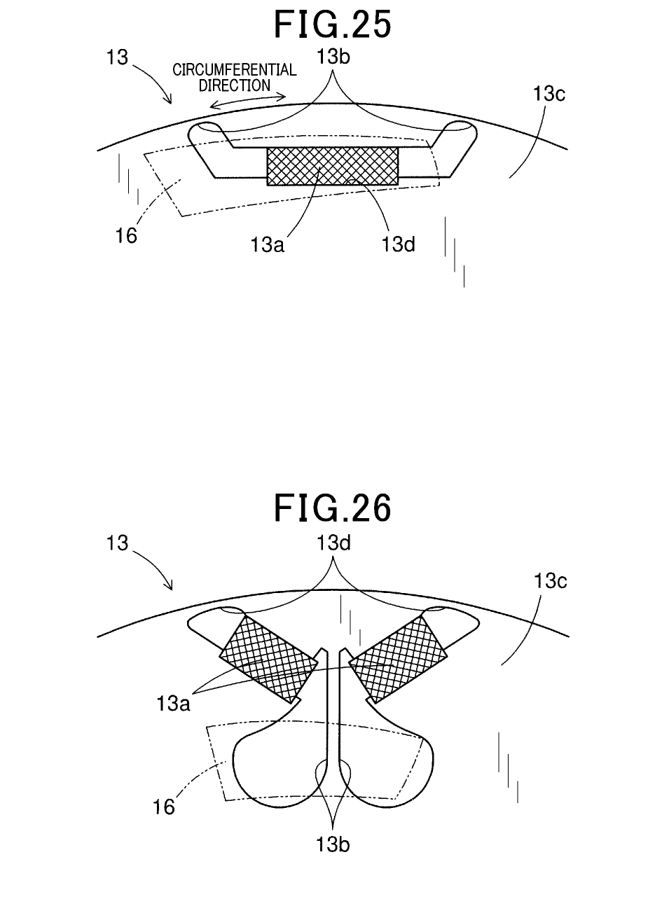

In the first to fourth embodiments described above, as illustrated in FIGS. 2 and 24, the number of poles of the rotor 13 is set to eight and two each magnets 13a are provided for each pole. Instead of this mode, in a modification example, the number of poles of the rotor 13 may be set to any value other than eight. In addition, as illustrated in FIG. 25, one each magnet 13a may be provided for each pole. In the rotor 13 illustrated in FIG. 25, the magnet 13a is stored in the storage hole 13d. The through hole 13b is provided from both sides of the storage hole 13d in the circumferential direction of the rotor 13. The introduction member 16 indicated by two-dot chain lines is provided to introduce the refrigerant 18a or 18b into the two through holes 13b. Three or more magnets 13a may be provided for each pole (not illustrated). One magnet 13a may be formed from a plurality of partial magnets. In this way, the present modification example and the first to fourth embodiments are different only in the number of the magnets 13a provided for each pole. Accordingly, in the present modification example, the same advantageous effects as those of the first to fourth embodiments can be obtained.

In the first to fourth embodiments, the through holes 13b and the storage holes 13d are formed in the shapes as illustrated in FIGS. 2 to 4, 19, 20, and 24. Instead of this mode, in a modification example, the through holes 13b and the storage holes 13d may be formed in the shapes as illustrated in FIG. 26. That is, the through holes 13b can be implemented in any shape on the condition that the refrigerant 18a or 18b can flow. The storage holes 13d can be implemented in any shape on the condition that the magnets 13a can be stored. In this way, the present modification example and the first to fourth embodiments are different only in the shapes of the through holes 13b and the storage holes 13d. Accordingly, in the present modification example, the same advantageous effects as those of the first to fourth embodiments can be obtained.

In the first to fourth embodiments, as illustrated in FIGS. 1, 18, 21, and 22, the introduction members 16 and the side plate 17 are integrally molded. Instead of this mode, in a modification example, the separately molded introduction members 16 and side plate 17 may be fixed together. In this configuration, as illustrated in FIGS. 15 and 16, the communication portion 16c and the through hole 17b are desirably formed in the same shape. In addition, referring to FIG. 17, the opening area of a second communication portion 16c2 is made smaller than the opening area of a first communication portion 16c1. Instead of this mode, in a modification example, the opening area of the through hole 17b corresponding to the second communication portion 16c2 may be made smaller than the opening area of the through hole 17b corresponding to the first communication portion 16c1. In this way, the present modification example and the first to fourth embodiments are different only in whether the introduction members 16 and the side plate 17 are formed integrally or separately. Accordingly, in the present modification example, the same advantageous effects as those of the first to fourth embodiments can be obtained.

In the first to fourth embodiments, the technique in the present disclosure is applied to the inner rotor-type rotary electrical machines 10. Instead of this mode, in a modification example, the technique in the present disclosure may be applied to outer rotor-type rotary electrical machines. In this way, the present modification example and the first to fourth embodiments are different only in the arrangement of the stator 11 and the rotor 13. Accordingly, in the present modification example, the same advantageous effects as those of the first to fourth embodiments can be obtained.

### REFERENCE SIGNS LIST

1 . . . Rotary electrical machine

11 . . . Stator

13 . . . Rotor

13a . . . Magnet

13b . . . Through hole

13c . . . Rotor core

13d . . . Storage hole

16 . . . Introduction member

16a . . . Intake portion

16b . . . Protrusion portion

16c . . . Communication portion

17 . . . Side plate

18a, 18b . . . Refrigerant

1. A rotary electrical machine comprising:
a rotor that includes one or more magnets and one or more through holes penetrating in an axial direction; and
a stator that is opposed to the rotor, wherein
the rotary electrical machine has an introduction member that communicates partially or entirely with the one or more penetration holes and introduces a refrigerant, and
the introduction member includes a protrusion portion that protrudes axially from an end surface of the rotor, an intake portion that is provided at one end of the protrusion portion and is opened toward a rotational direction of the rotor to take in the refrigerant, and a communication portion that is provided at the other end of the protrusion portion and communicates with the opening.

2. The rotary electrical machine according to claim 1, wherein
the magnet is arranged closer to an outer radial side than to the through hole.

3. The rotary electrical machine according to claim 2, wherein
the through hole communicates with a storage hole storing the magnet and has a barrier function to prevent magnetic leakage of the magnet.

4. The rotary electrical machine according to claim 1, wherein
the introduction member is scoop-shaped.

5. The rotary electrical machine according claim 1, wherein
the intake portion is positioned closer to the outer radial side than to the communication portion.

6. The rotary electrical machine according to claim 5, wherein
the intake portion includes an outer radial-side wall portion and an inner radial-side wall portion that extend axially from the end surface of the rotor, and
the outer radial-side wall portion has an inclination angle α and the inner radial-side wall portion has an inclination angle β, and the inclination angles α and β are in a relationship α>β.

7. The rotary electrical machine according to claim 1, wherein
the introduction member has an internal height of the protrusion portion that is gradually smaller from the intake portion toward the communication portion.

8. The rotary electrical machine according to claim 1, wherein
the introduction member has a surface-direction width of the protrusion portion that is gradually smaller from the intake portion toward the communication portion along the end surface of the rotor.

9. The rotary electrical machine according to claim 1, wherein
the introduction members are provided on both end surfaces of the rotor, and
the introduction members are provided such that the through hole communicating with one end surface and the through hole communicating with the other end surface are different.

10. The rotary electrical machine according to claim 1, wherein
the introduction member is provided such that the communication portion communicates with a plurality of the openings, and
the refrigerant is branched so that an equal amount of refrigerant flows into the plurality of openings.

11. The rotary electrical machine according to claim 10, wherein
the plurality of openings is provided on a front side and a rear side with respect to the rotational direction of the rotor, and
a first space from the opening on a front side to the inner wall surface of the protrusion portion has a volume Vf and a second space from the opening on a rear side to the inner wall surface of the protrusion portion has a volume Vr, and the volumes Vf and Vr are in a relationship Vf>Vr.

12. The rotary electrical machine according to claim 1, wherein
the introduction member is molded integrally with a side plate provided on the end surface of the rotor.

13. The rotary electrical machine according to claim 1, wherein a material for the introduction member is a non-magnetic body or a material including a non-magnetic body.
